(19) United States
(12) Patent Application Publication
(10) Pub. No.: US 2002/0087623 A1
(43) Pub. Date: Jul. 4, 2002

(54) Method and apparatus for determining network topology and/or managing network related tasks

(76) Inventor: David A. Eatough, Herriman, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,202

(22) Filed: Dec. 30, 2000

(51) Int. Cl. G06F 15/16; G06F 9/00

(52) U.S. Cl. 709/203; 709/100

(57) ABSTRACT

Numerous embodiments for a method and/or apparatus for determining network topology and/or managing network related tasks are disclosed.

### BACKGROUND

1. Field

This disclosure relates to networking, and more particularly, to determining network connections and/or available bandwidth on a local area network (LAN), wide area network (WAN), or other type of network, and/or scheduling tasks to correspond with available bandwidth.

2. Background Information

A network, such as a computer network, comprises a distributed system of intercoupled data links, typically for the purpose of exchanging data between various locations. Networks vary in size and speed of data transfer, and are becoming much more complex. A need exists for an efficient network management system that will allocate bandwidth and/or schedule the completion of prescribed tasks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart illustrating a method of determining network topology and/or managing network related tasks in accordance with one embodiment of the present invention.

FIG. 2 is a flowchart illustrating the implementation of a task pool in accordance with an embodiment of the invention.

FIG. 3 is a schematic diagram illustrating one embodiment of the invention interacting with a computing platform and a network resource.

FIG. 4 is a block diagram illustrating a processing system in accordance with one embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An area of current technological development relates to networks and network task management. As previously described, a network comprises a distributed system of intercoupled data links, typically for the purpose of exchanging data between various locations. In this context, network environments employ applications, usually in the form of software, that run or execute periodically, and often remotely, for varying purposes, such as software upgrades and information downloads. Network bandwidth will typically vary for each given task, and available bandwidth may or may not be adequate to process a specified task at the time when the task is to be processed. In this context, network bandwidth refers to the ability to transfer data across a given network, usually, although not necessarily, measured in Kilobits or Megabits of data transfer per unit time. Network related tasks will often be processed based on a first in/first out rule (FIFO), which typically does not consider factors, such as the relative size of a task, or the importance of the particular task or tasks in terms of type of task such as an operating system upgrade, for example. A network management system that monitors network connectivity and/or bandwidth, and/or allocates bandwidth and processes scheduled tasks based at least in part on the bandwidth to be employed and the bandwidth available, as well as based at least in part on a priority system, may, therefore, be desirable.

In accordance with one embodiment of the invention, a method and/or apparatus for determining network topology and/or managing network related tasks comprises a task pool that contains network related tasks that are to be processed. In this embodiment, tasks within a task pool receive a priority designation. The priority value may also be based on any number of factors, as explained in more detail later. In this context, processed refers to the initiation of a network related task and the completion of a network related task. In this embodiment, ICMP (Internet Control Message Protocol) may be employed to create and send a PING (Packet Internet Groper) to any or all nodes on a given network, or a subset of the network, although the invention is not limited to ICMP. Here, upon finding an active connection to a network resource, this particular embodiment of the invention will then transmit a bandwidth PING in order to estimate available bandwidth. Of course, the invention is not limited to just this method of determining network connectivity and bandwidth, as explained in more detail later. Nonetheless, in this particular embodiment, upon receipt of the bandwidth estimate, the bandwidth is compared to the tasks in a task pool that was created to keep track of tasks that are to be processed across a network, but for reasons that may include insufficient bandwidth, have not been processed yet. Therefore, in this embodiment, upon receipt of the bandwidth estimate, one or more of the tasks that have a bandwidth value that is less than or equal to the estimated bandwidth available may then be processed. If more than one task in a task pool meets these criteria, priority values may be utilized to determine which task(s) to process. It will, of course, be understood that this is one possible embodiment, and the invention is not limited in this respect.

It is well-known that a PING comprises a program that utilizes ICMP to transmit electronic information across a network. ICMP is a protocol that is commonly known and used in the art. Details of the protocol may be found, for example, in Request for Comments (RFC) 792, available on the World Wide Web (WWW) at the following URL: http://194.52.182.96/rfc/rfc792.html This PING program may be utilized to determine connectivity and reliability of nodes on a given network by continually requesting echo responses from any or all nodes coupled to a given network, and may track packet loss and round trip time of the packets, which are also known as determining network topology. In this context, a node refers to any computer, server or other device that is coupled to a given network, and is capable of receiving a PING. The electronic information that is transmitted to a destination node includes a request for the destination node to transmit information back to the source node that previously sent the PING. This process is commonly known as a PING and echo response. This PING may be used in a variety of network types, such as, for example, Local Area Networks (LAN), Wide Area Networks(WAN), or dialup connections. In accordance with such embodiments of the invention, bandwidth PING may then be utilized to provide an estimate of the available bandwidth between a source node and a destination node. This information may further be used to determine what type of network connection has been established, such as WAN, LAN, or others. Bandwidth PING, also known as BING, was developed by Pierre Beyssac, and is commonly known in the art. More information may be obtained, for example, on the World Wide Web (WWW) at the URL: http://www.cnam.fr/reseau/BING.html. Employing a BING typically does not provide an exact measurement of bandwidth, but rather provides an estimate. The process for estimating network bandwidth includes, typically, transmitting a packet of known size across a network, measuring the throughput time of the packet, and estimating bandwidth based at least in part on this information. The estimate of bandwidth obtained by a BING is usually sufficient to categorize a network connection into a class or category such as a WAN, LAN, dialup connection, or any other type of network connection. Of course, the invention is not limited in scope to PING and/or BING or to just using ICMP, as explained in more detail later.

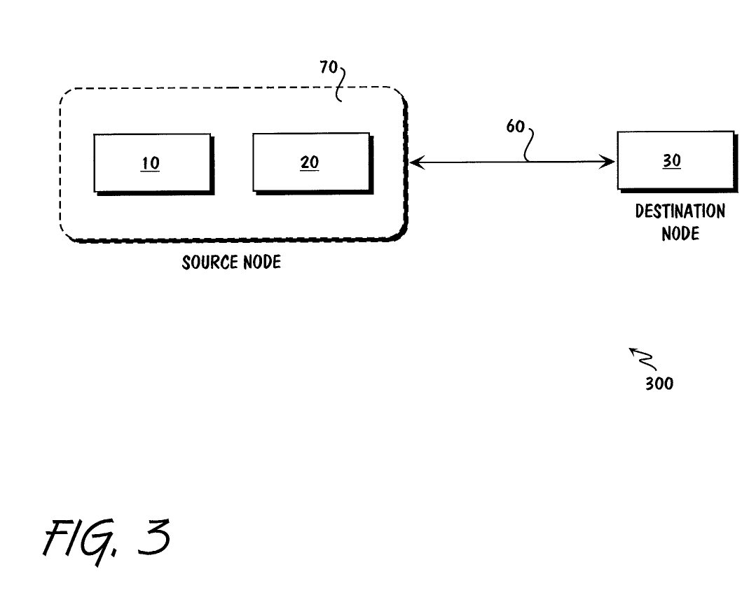

FIG. 3 is a schematic diagram of a system 300 demonstrating one embodiment 20 of the present invention interacting with or executing on a computing platform 70 and in communication with a network resource 30. Platform 70 includes an application or task 10 also executing on the platform 70, and at least partially transmits information or data across a network to a network resource 30, as described in more detail hereinafter. Network resource 30 may, for example, comprise a server, desktop computer, or any of a number of devices that may be coupled to a network. Embodiment 20 here includes software having the capability, while executing, to maintain a task pool of network related tasks that are to be processed across a network. Embodiment 20 here also includes a method for determining network topology, such as one that includes transmission of a PING frame, and transmission of a bandwidth PING upon receipt of an echo response from the network resource 30. Embodiment 20 may also further include a method for initiation of tasks across a network, although the invention is not limited in scope in this respect. In this embodiment, computing platform 70 embodies applications 10 and 20 as software applications, although the invention is not limited in scope in this respect. For example, 10 and 20 may be embodied as hardware, firmware, or some combination thereof. Transmission path 60 comprises a signal path for a PING from and to a network resource, and for an echo response sent from the network resource to computing platform 70, here designated as a source node. Transmission path 60, in this embodiment, also provides a path for the transmission of a bandwidth PING and bandwidth PING echo response. Of course, it will be understood that this is just one embodiment of the present invention, and the invention is not limited in this respect.

In accordance with one embodiment of the invention, a method of maintaining a pool of applications or tasks may further comprise registering in a task pool a task or set of tasks that are yet to be processed across a network, assigning a priority or priority value to each task in a task pool, and then removing tasks from a task pool substantially depending upon the processing of the task. In this embodiment, a task pool may comprise a file containing the names and locations of tasks that are to be processed across a network, or it may comprise a database or a registry, or any number of other types of persistent storage mechanisms, but the invention is not limited in scope to a particular storage mechanism. In this embodiment, the task pool may be stored on a remote network resource, or it may be stored on a resident system, but the invention is again not limited in this respect. In this context, a resident system, such as a computer system, comprises the computer system that runs or executes the network management system, and also comprises the source node. A remote network resource, in this embodiment, refers to any computing platform that is coupled to a network, such as, for example, a server or a remote desktop system that is not a resident computing platform.

In accordance with one embodiment of the present invention, a method of assigning a priority value to network related tasks comprises determining the bandwidth to be employed in order to process a given task, and comparing this priority value to the priority values of other tasks in a task pool. A priority value, in this embodiment, is assigned based at least in part on the relative amounts of bandwidth to be employed in processing each task. In this context, determining bandwidth comprises determining the file size of a task, which may be measured in Kilobytes or Megabytes, for example, in this embodiment. In one such embodiment, a priority value is assigned based at least in part on the file size of a task, where the highest priority value is assigned to the task with the smallest file size. Of course, the invention is not limited in this respect. For example, a priority value may be highest for the tasks with the largest file size, or a priority value may be based on some other factors, which may be determined by a user or by a software application, for example. In this embodiment, substantially determining bandwidth to be employed for a given task may be completed by any one of a number of techniques, such as an automated calculation based at least in part on the size of the application, by having a user provide it, or by an approximation performed by a computing platform based at least in part on the type of application that comprises a task. For example, a message may be given a high priority value, whereas an operating system upgrade may be given a low priority value, in one such embodiment, but the invention is not limited in this respect. Alternatively, bandwidth to be employed may be determined by the task itself, and the task may request a particular type of network connection, for example, LAN, WAN, dialup, or any other type of network connection. In one such embodiment, the type of network connection requested by the task may be converted to a numerical value of bandwidth, and this numerical value of bandwidth may then be used to determine the priority value of a given task, although, again, the invention is not limited in this respect. In such an embodiment, however, a method of assigning priority may also be based at least in part on size of the application, approximated time to process the application, or on the time of day that task(s) are requested to be processed, or, as previously described, available bandwidth, the type of application, or any combination thereof. Of course, these are just examples and the invention is not limited to any of these particular approaches. The priority value of a task may also be assigned by a user or through a user interface, or it may be assigned by an automated method that uses any criteria such as those discussed above. Again, the invention is not limited to these particular approaches, however. For example, a user may determine and supply the priority value for a task based on a subjective importance that the user places on processing of the associated task. In another alternative embodiment, a method of updating a task pool may comprise deleting a task from a task pool, or placing a task that has been processed in a different file, or any number of other approaches to distinguish completed tasks. Alternatively, a task may be designated as completed and not removed from a task pool but designated as being complete. In such embodiments, the updating of the task pool may be performed by a user through a user interface, or it may be performed by an automated method that determines when a task has been processed, or completed. Of course, these are just examples, as stated previously.

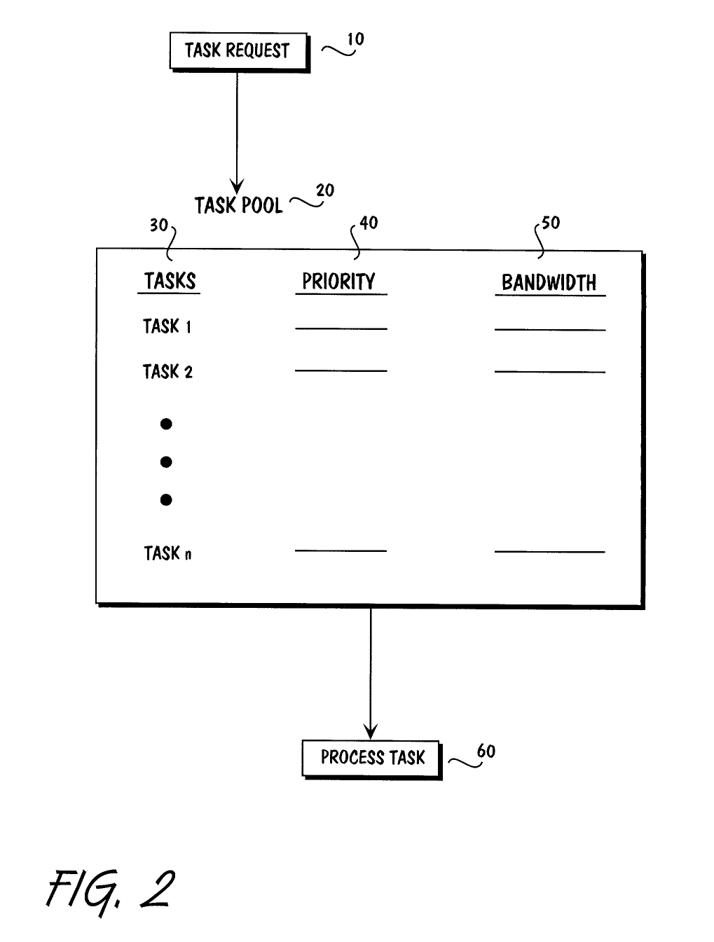

FIG. 2 is a schematic, which demonstrates a process for maintaining a task pool, in accordance with one embodiment of the present invention. Block 10 designates a task request, which may comprise sending the complete file comprising the task, or may comprise sending a command line parameter, just to provide some implementation examples. Block 20 designates a task pool, which in one embodiment may be stored on a resident computing system, but as explained previously, may also be stored on a remote network resource. In this embodiment, the task pool comprises a collection of tasks to be processed, designated 30 in FIG. 2, and may comprise a database containing the complete task file, or may comprise a registry of task file locations, or any number of other suitable ways to track tasks. The task list in this embodiment also stores an associated priority or priority value for each task, designated 40 in FIG. 2. In this embodiment, a priority value is assigned after a task is added to a task pool, but alternative ways to assign a priority value are also possible, such as, for example, assigning a priority prior to storing a task in a task pool. In FIG. 2, 50 designates the bandwidth to process an associated or corresponding task. In this embodiment, the bandwidth value is determined when a task is placed in the task pool, but the invention is not limited in this respect. For example, bandwidth may be determined prior to a task being added to a task pool, or a task may request a particular amount of bandwidth, in which case, determination of bandwidth based on file size may be omitted. In this embodiment, a task is processed, designated 60, when appropriate based at least in part on the foregoing parameters. The task may be processed by a file management program, it may be initiated by a command line located in the task itself, or it may be initiated by a user. It will, of course, be understood that FIG. 2 is one embodiment of the present invention, and the invention is not limited in this respect.

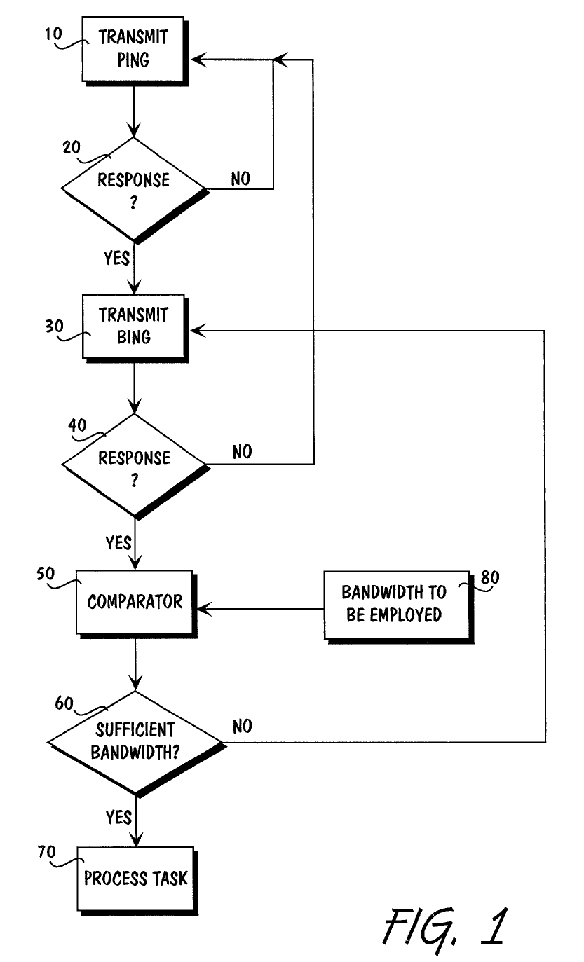

FIG. 1 is a flowchart showing a method of determining network connectivity and bandwidth, and initiation of a task, in accordance with one embodiment of the present invention. Block 10 represents the action of a source node on a given network transmitting a PING to a particular destination node on the network. Block 20 is a decision block that determines whether an echo response was received from the network. If an echo response was not received, then block 10 is reinitiated, in this particular embodiment, and a PING will be transmitted to another destination node on the network. If an echo response is received, then block 30 represents the transmission of a bandwidth PING, or BING, to the destination node that returned an echo response in block 20. Block 40 is a decision block that determines if the destination node returned a bandwidth echo. If the destination node did not transmit a bandwidth echo, then, in this embodiment, block 10 is reinitiated and the process will begin again. If the source node does receive a bandwidth echo, block 50 illustrates application of a comparator function that compares the determined bandwidth, which is determined externally to this process and is represented by block 80, to the available approximated bandwidth determined by the bandwidth PING. If there is not sufficient bandwidth, then, in this embodiment, block 60 sends the process back to block 30, and the bandwidth PING is transmitted again. If there is sufficient bandwidth, in one particular embodiment, the task is processed, as represented by block 70. It will, of course, be understood that FIG. 1 is one embodiment, and the invention is not limited to just this method of determining network connectivity and bandwidth. For example, an alternative embodiment of the present invention may utilize a different form of PING to transmit to any or all nodes of a given network, or to a subset of the network, in another embodiment. In this embodiment, a source node will transmit a file of known size to any or all nodes on a given network, and may determine substantially which nodes respond to the file by transmitting substantially the same file back to the source node. A computing system coupled to the network may track the time it takes for the file to reach its destination and return to the source node, and, from this information, estimate the bandwidth available between the source node and the destination node.

In accordance one embodiment of the present invention, a method of managing tasks on a network may include maintaining a pool of network related tasks to be completed, assigning priority to at least a portion of the network related tasks in a task pool, periodically monitoring network connectivity and available bandwidth on a particular network, and processing tasks, based at least in part on a priority value basis, across a particular network. In such an embodiment, a task comprises a transfer of data across a network, and may include software uploading or downloading, the transmitting of a message, or a variety of other types of data transfer, but the invention is not limited in scope in this respect. Here, tasks may be placed in a task pool by automated system or a resident application, or may be entered by a system user or network administrator, although, again, the invention is not limited in this respect. In an alternative embodiment, a user may determine a task that is to be completed for a given computing system; however; the bandwidth to process the task may not immediately be available. In such an embodiment, as previously described, the task may be placed in a task pool. A task pool may comprise, for example, tasks, which in this context means the entire application that is to be at least partially transferred across a network, it may comprise a file containing names of tasks, a folder containing the files in the task pool, or a set of instructions designating where to locate task(s), any of which may be located on a resident computer system or may be located at some external location. Of course, these are just examples and are not intended to limit the scope of the invention. In such an embodiment, however, the user may determine or provide priority values, as previously described. In one such embodiment, a task management system may periodically monitor network connectivity and/or available bandwidth in accordance with one of the embodiments previously described, and when a task management system determines that a particular task is to be processed, it may notify the user that the user should process the task. The user would then initiate the task by a command line, or any number of other methods. Alternatively, of course, task processing may be automated. In another alternative embodiment of the present invention, a user may not interact with the method and/or apparatus for determining network topology and/or managing network related tasks. For example, a computing platform may determine that a particular task is to be processed. However, the computing platform may not process that task due to a lack of sufficient bandwidth, or due to a particular criteria not being satisfied, such as date or time, or for a variety of other reasons. In this embodiment, the computing platform may place the task into a task pool, which may comprise a file folder, a database, or a registry that stores the location of particular tasks, as previously described. In another alternative embodiment, a method for determining network topology may comprise sending bandwidth PINGs to any and all nodes of a given network, where only those nodes that are coupled will respond with a bandwidth echo. In this alternative embodiment, a bandwidth PING performs the functions of determining both network connectivity and bandwidth. If bandwidth sufficient to process a task has been reached, or if a particular node has been successfully contacted, a task may be processed based upon the priority value assigned to the particular task. Initiation of a task may be performed by a command line in the task, or it may be performed by a file manager, or any number of other methods, as previously described. The task that is processed may then be removed from the task list, or may be designated as processed in the task pool, or any number of other methods that provide notice that the task has been processed. Of course, these are just examples of potential embodiments, and are not intended to limit the scope of the invention.

Embodiments of the present invention may be implemented in hardware or software, or a combination of both. However, embodiments of the invention may be implemented as computer programs executing on programmable systems comprising at least one processor, a data storage system, which includes volatile and non-volatile memory and/or storage elements, at least one input device, and at least one output device. Program code may be applied to input data to perform the functions described herein and generate output information. The output information may be applied to one or more output devices, in known fashion. For purposes of this application, a processing system embodying the task management components and network topology components includes any system that has a processor, such as, for example, a digital signal processor (DSP), a microcontroller, an application specific integrated circuit (ASIC), or a microprocessor.

The programs may be implemented in a high level procedural or object oriented programming language to communicate with the processing system. The programs may also be implemented in assembly or machine language, if desired. In fact, the invention is not limited in scope to any particular programming language.

The programs may be stored on a removable storage media or device, such as, for example, floppy disk drive, read only memory (ROM), CD-ROM device, flash memory device, digital versatile disk (DVD), or other storage device, readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

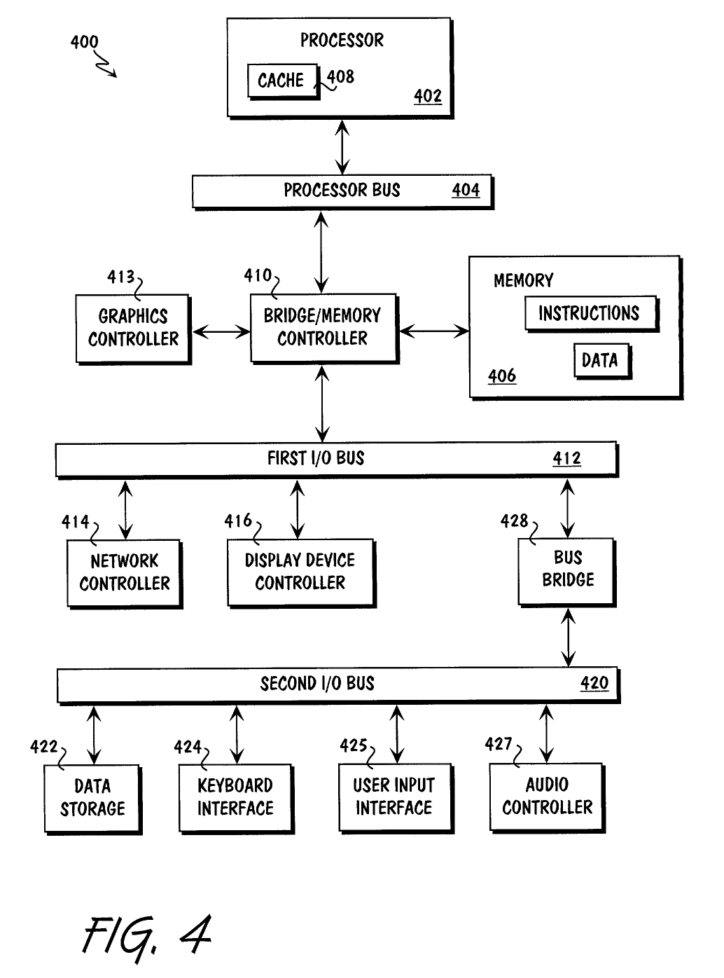

An example of one such type of processing system is shown in FIG. 4, however, other systems may also be used and not all components of the system shown are required for the present invention. Sample system 400 may be used, for example, to execute the processing for embodiments network management system, in accordance with the present invention, such as the embodiment described herein. Sample system 400 is representative of processing systems based on the PENTIUM®II, PENTIUM® III, and CELERON™ microprocessors available from Intel Corporation, although other systems (including personal computers (PCs) having other microprocessors, engineering workstations, other set-top boxes, and the like) and architectures may also be used.

FIG. 4 is a block diagram of a system 400 of one embodiment of the present invention. The system 400 includes a processor 402 that processes data signals. Processor 402 may be coupled to a processor bus 404 that transmits data signals between processor 402 and other components in the system 400.

System 400 includes a memory 406. Memory 406 may store instructions and/or data represented by data signals that may be executed by processor 402. The instructions and/or data may comprise code for performing any and/or all of the techniques of the present invention. Memory 406 may also contain additional software and/or data (not shown). A cache memory 408 may reside inside processor 402 that stores data signals stored in memory 406.

A bridge/memory controller 410 may be coupled to the processor bus 404 and memory 406. The bridge/memory controller 410 directs data signals between processor 402, memory 406, and other components in the system 400 and bridges the data signals between processor bus 404, memory 406, and a first input/output (I/O) bus 412. In this embodiment, graphics controller 413 interfaces to a display device (not shown) for displaying images rendered or otherwise processed by the graphics controller 413 to a user.

First I/O bus 412 may comprise a single bus or a combination of multiple buses. First I/O bus 412 provides communication links between components in system 400. A network controller 414 may be coupled to the first I/O bus 412. In some embodiments, a display device controller 416 may be coupled to the first I/O bus 412. The display device controller 416 allows coupling of a display device to system 400 and acts as an interface between a display device (not shown) and the system. The display device receives data signals from processor 402 through display device controller 416 and displays information contained in the data signals to a user of system 400.

A second I/O bus 420 may comprise a single bus or a combination of multiple buses. The second I/O bus 420 provides communication links between components in system 400. A data storage device 422 may be coupled to the second I/O bus 420. A keyboard interface 424 may be coupled to the second I/O bus 420. A user input interface 425 may be coupled to the second I/O bus 420. The user input interface may be coupled to a user input device, such as a remote control, mouse, joystick, or trackball, for example, to provide input data to the computer system. An audio controller 427 may be coupled to the second I/O bus for handling processing of audio signals through one or more loudspeakers (not shown). A bus bridge 428 couples first I/O bridge 412 to second I/O bridge 420.

Embodiments of the present invention are related to the use of the system 400 as a network related task management system. According to one embodiment, such processing may be performed by the system 400 in response to processor 402 executing sequences of instructions in memory 404. Such instructions may be read into memory 404 from another computer-readable medium, such as data storage device 422, or from another source via the network controller 414, for example. Execution of the sequences of instructions causes processor 402 to execute network management processing according to embodiments of the present invention. In an alternative embodiment, hardware circuitry may be used in place of or in combination with software instructions to implement embodiments of the present invention. Thus, the present invention is not limited to any specific combination of hardware circuitry and software.

The elements of system 400 perform their conventional functions in a manner well known in the art. In particular, data storage device 422 may be used to provide long-term storage for the executable instructions and data structures for embodiments of the network management system in accordance with the present invention, whereas memory 406 is used to store on a shorter term basis the executable instructions of embodiments of the network management system in accordance with the present invention during execution by processor 402.

While certain features of the invention have been illustrated as described herein, many modifications, substitutions, changes, and equivalents will now occur to those skilled in the art. It is, therefore, to be understood that the appended claims are intended to cover all such embodiments and changes as fall within the true spirit of the invention.

What is claimed is:

1. A method of managing network related tasks on a network, said method comprising:
(a) maintaining a pool of said network related tasks;
(b) assigning a priority value to at least a portion of said network related tasks, wherein said priority value is based at least in part on network bandwidth to be employed in order to process said network related tasks;
(c) periodically monitoring available network bandwidth on said network; and
(d) processing said network related tasks based at least in part on the priority values, and the available network bandwidth.

2. The method of claim 1, and further comprising:
creating the task pool based at least in part on a pool of uncompleted network related tasks.

3. The method of claim 2, and further comprising:
entering additional network related tasks into the task pool through a user interface.

4. The method of claim 2, and further comprising:
entering additional network related tasks into the task pool automatically via a computing system coupled to said network.

5. The method of claim 1, wherein maintaining the task pool comprises updating the task pool based at least in part on completed tasks.

6. The method of claim 1, wherein the priority value for at least one task of said network related tasks is determined based at least in part on the file size of said at least one task, wherein said at least one task further comprises at least one file.

7. The method of claim 1, wherein periodically monitoring available network bandwidth comprises sending a PING across said network, receiving an echo response across said network, sending a bandwidth PING across said network, and receiving a bandwidth response across said network.

8. The method of claim 1, wherein monitoring available network bandwidth comprises transferring a data file across a network, and determining an estimate of available bandwidth based at least in part on the elapsed time to transfer said data file.

9. The method of claim 1, wherein processing at least one task of said network related tasks comprises executing a command line in said at least one task of said network related tasks.

10. The method of claim 1, wherein processing said network related tasks comprises initiation by a resident application, wherein a resident application further comprises software capable of initiating tasks.

11. A method of substantially determining network connectivity and bandwidth, said method comprising:
(a) transmitting a PING (Packet Internet Groper) from a source node on said network to a destination node on said network;
(b) receiving an echo response at said source node from said destination node;
(c) transmitting a bandwidth PING from said source node to said destination node;
(d) receiving a bandwidth echo at said source node; and
(e) reporting at least a portion of the data received in (b) and (d) to a network management system.

12. The method of claim 11, and further comprising:
repeating steps (a), (b), (c), (d) and (e) for any other source node coupled to said network.

13. The method of claim 11, wherein said PING and said echo response substantially conform with Internet Control Message Protocol (ICMP).

14. The method of claim 11, wherein said bandwidth PING and said bandwidth echo substantially conform with Beyssac protocol.

15. A method of maintaining a task pool on a network management system, said method comprising:
(a) adding a task to said task pool;
(b) estimating the bandwidth to be employed to complete said task;
(c) assigning a priority value to said task, wherein said priority value is based at least in part on the estimated bandwidth; and
(d) updating said task pool based at least in part on completion of said task.

16. The method of claim 15, and further comprising:
creating said task pool based at least in part on a list of uncompleted tasks.

17. The method of claim 16, and further comprising:
adding a task to said task pool via a user interface.

18. The method of claim 16, and further comprising:
adding a task to said task pool automatically via a resident application.

19. The method of claim 15, wherein assigning a priority value includes obtaining a priority value from an external source.

20. The method of claim 15, wherein assigning a priority value includes assigning a priority value via an automated methodology.

21. The method of claim 15, wherein assigning a priority value comprises comparing the estimated bandwidth with available bandwidth on said network.

22. The method of claim 15, wherein updating said task pool comprises removing said task from said task pool based at least in part on completion of said task.

23. An article comprising:
a storage medium having stored thereon instructions, that, when executed by a computing platform, result in execution of a network management system by:
maintaining a pool of said network related tasks; assigning a priority value to at least a portion of said network related tasks, wherein said priority value is based at least in part on network bandwidth to be employed in order to process said network related tasks;
periodically monitoring available network bandwidth on said network; and processing said network related tasks based at least in part on the priority values, and the available network bandwidth.

24. The article of claim 23, wherein said storage medium further has stored instructions thereon that, when executed, result in the initiation of said network related tasks by an automated methodology.

25. The article of claim 23, wherein said priority values are assigned based at least in part on the file size of an associated task.

26. The article of claim 23, wherein said priority values are assigned at least in part based on a measure of the importance of said network related tasks, wherein the value of the measure of the importance is determined by an external source.

27. The article of claim 23, wherein maintaining said task pool comprises updating the task pool based at least in part on completed and uncompleted tasks.

28. A system for managing network related tasks comprising:
a computing platform being adapted to, in operation, perform the management of network related tasks by:
maintaining a pool of said network related tasks;
assigning a priority value to at least a portion of said network related tasks, wherein said priority value is based at least in part on network bandwidth to be employed in order to process said network related tasks;
periodically monitoring available network bandwidth on said network; and processing said network related tasks based at least in part on the priority values, and the available network bandwidth.

29. The system of claim 28, wherein maintaining said task pool comprises removing network related tasks from said task pool based at least in part on completion of said network related tasks.

30. The system of claim 28, wherein said network related tasks are initiated via an automated methodology.

31. The system of claim 28, wherein said priority values are assigned based at least in part on the importance of the associated tasks, wherein the importance is determined by an external source.

32. The system of claim 28, wherein said priority values are determined based at least in part on a file size of the associated task.
